(19) United States
(12) Patent Application Publication
(10) Pub. No.: US 2008/0251773 A1
(43) Pub. Date: Oct. 16, 2008

(54) Cam jack

(75) Inventors: Robert Smeeton, Central Square, NY (US); Peter Csigi, Liverpool, NY (US)

Correspondence Address: BERNHARD P. MOLLDREM, JR., 224 HARRISON STREET, SUITE 200, SYRACUSE, NY, 13202, US

(73) Assignee: Belle Technologies LLC

(21) Appl. No.: 11/786,947

(22) Filed: Apr. 13, 2007

(51) Int. Cl. B66F 3/00

(52) U.S. Cl. 254/113

(57) ABSTRACT

A cam jack has an L-shaped unitary body portion, with a lever arm and a cam finger and an elbow formed between them. A pair of rollers are supported on an axle that is affixed at the elbow. A socket or fitting formed at the proximal end of the lever arm allows a lever handle to be removably attached. The cam finger is oriented at a near right angle to the lever arm. When the lever arm is disposed vertically, the cam finger can be positioned under the item to be lifted, and then as the lever arm is rocked downward as lobe tip of the cam finger urges the item upward. When the lever arm is positioned horizontally against the floor, the lobe tip is displaced outward past the axle of the rollers, so there is an over the center action holding the cam jack stable while supporting the load. An additional set of rollers can be present so the device may be used as a dolly.

### BACKGROUND OF THE INVENTION

This invention relates to jacks or lifts for raising heavy machines or equipment, and is more particularly concerned with a hand-operated cam jack which is convenient in size and weight, and which employs simple lever action to lift a machine up off the supporting floor surface, and which can hold the same stably at an elevated position.

At present, there is no simple means available for raising heavy equipment off the floor when it is necessary to service the equipment. For most types of equipment, a heavy service equipment item, such as railroad jack, or sometimes a forklift, is brought in and the forks are slid under the machine. This is almost always an inconvenient and time consuming procedure, and an expensive use of resources.

One example of an application for a simple jack in a materials handling vehicle, such as a pallet transporter, which typically has groups of wheels held in place on horizontal support legs at the base of the unit. In a typical warehouse operation, these wheels can wear unevenly, and need to be replaced rather frequently. When that is needed, a device must be inserted under the support leg(s) to lift the same, and to relieve the weight from the wheels. Then the wheels can be changed out. The difficulty in this maintenance function has been that it requires a heavy, cumbersome tool such as a railroad jack, and there is no effective light-weight, convenient lifting mechanism for raising the machine a short distance off the floor and then also serving as a stable support to hold the unit securely in that position until the wheels have been changed out. Of course, any device would need to ensure that the operation is conducted in a safe manner, and can be carried out without difficulty, both in raising the machine and in lowering it again after the wheel replacement has been completed.

### OBJECTS AND SUMMARY OF THE INVENTION

Accordingly, it is an object of this invention to provide simple, convenient, light-weight, and effective lifting tool capable of safely and securely lifting heavy equipment, and which avoids the drawbacks of the prior art.

It is another object to provide a cam jack that is of simple, sturdy construction.

It is a further object to provide a cam jack that capable of being operated by hand, and which is quick and convenient to insert in place under the equipment, and which can raise the equipment using a simple lever operation.

It is another object to provide a cam jack that holds the equipment in a stable, secure elevated position until it is lowered by lever action.

A still further object is to avoid creating a tripping hazard on the factory or warehouse floor.

Yet another object is to provide a cam jack that is fabricated in a way that ensures that it can be used in lifting very heavy equipment without danger of breakage or failure.

In accordance with an aspect of the present invention, a cam jack is adapted for lifting a heavy machine off a supporting floor surface. The cam jack has a body member in the form of an L-shaped cam member, which is unitarily formed of a single piece of steel. This body member is shaped so as to define a lever arm portion, a cam finger, and an elbow formed between the lever arm portion and the cam finger. An axle is attached at the elbow and extends to its right and left sides. There are left and right rollers supported on the axle on the respective sides of said elbow. These rollers have a selected, predetermined diameter, to the top surface of the rollers are at a desired upper level above the floor surface. The cam finger projects from the elbow and axle at a near right angle in respect to said lever arm portion. The cam finger has an upper surface, considered from when said lever arm is oriented vertically, which is disposed at or below the upper level of said rollers. This cam finger also has a lobe tip which, when the lever arm is tipped down to horizontal, projects above the upper surface of the rollers a distance sufficient to lift the intended machine or equipment off the floor. The cam jack also has an over-the-center action, so that when the cam jack is in this horizontal position (with the machine or equipment supported off the floor) the lobe tip is displaced outward a short distance over the axle, that is, the lobe tip is displaced towards the lever arm member in respect to a vertical plane through the axle. This ensures that the cam jack remains locked in the lifting position until the cam jack is affirmatively lifted back towards the vertical position.

Preferably, the lever arm member has a socket or other fitting at its proximal end, permitting the cam jack to accept a removable lever handle. The lever handle is used for lifting and releasing the load, but can be removed when the cam jack is in place under the load so as to avoid having the lever handle constitute a tripping hazard.

The cam jack unitary body portion can be formed by cutting it with a water jet or similar tool, and this allows the body portion to be created so that the lever arm portion has generally planar left and right sides, a planar front surface, and a rear surface that has a major planar portion. Favorably, the major planar portion of the rear surface is oriented at an angle of substantially ten degrees in respect to said front surface. In a preferred implementation, the axle is formed of a single steel round rod that is supported at the elbow, and the rod projects to the left and right sides of the cam member.

In another possible implementation, the cam jack is also provided with a set of auxiliary rollers positioned at left and right sides of lever arm portion proximally of the main rollers. This arrangement allows the cam jack to be used as a dolly for moving heavy equipment.

The removable handle lever can be a bar, rod or tube. This may be of fixed length or may be constituted as an adjustable length handle.

The above and many other objects, features, and advantages of this invention will become apparent to persons skilled in the art from the ensuing description of a preferred embodiment, which is to be read in conjunction with the accompanying Drawing.

### BRIEF DESCRIPTION OF THE DRAWING

FIG. 1 is a perspective view of a cam jack according to one possible embodiment of the invention.

FIGS. 2 and 3 are side and front views thereof, respectively.

FIG. 4 is a side view, also showing the removable lever handle.

FIGS. 5 and 6 are perspective views showing the cam jack being used for lifting a portion of a materials transport vehicle, with the cam jack respectively in its vertical position to insert the device under the load, and in its horizontal or lift position holding the load off the floor to relieve weight on the wheels of the vehicle.

FIG. 7 is a perspective view of one alternative embodiment.

### DETAILED DESCRIPTION OF THE PREFERRED EMBODIMENT

With reference to the Drawing, FIGS. 1 to 4 illustrate a cam jack 10 that employs the principles of the present invention. Here, the cam jack 10 has a unitary body portion 12 that is formed from a single piece of steel, favorably about 2-½ inches in thickness. This can be fabricated by using a water jet tool, with a garnet abrasive to cut the body portion 12 into the desired profile. By use of this technique, the device can be formed of a very hard, strong grade of steel.

The body portion 12 is a generally L-shaped member, with a lever arm 14, and an elbow 16 formed at the distal end of the lever arm 14. There are rollers 18 mounted on an axle rod 20 that is supported in the elbow 16. A cam finger 22 projects from the elbow 16 at a nearly right angle with respect to the lever arm 14. As will be discussed later, the tip of the cam finger is angled slightly back, so that there is an over-the-center action to lock the cam jack in place in the raised position.

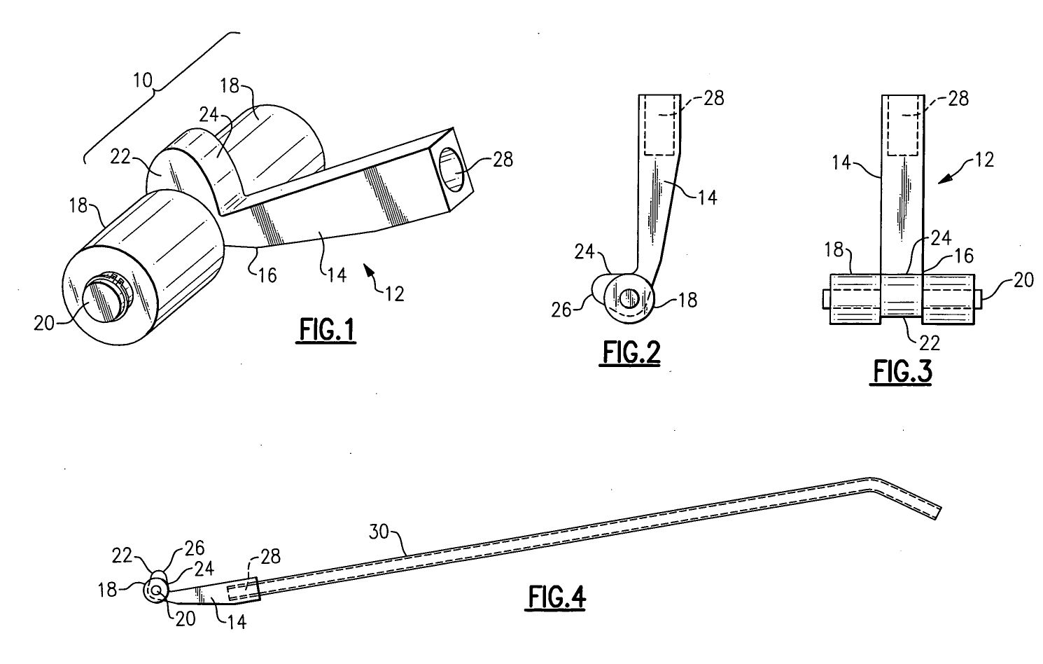

As can be seen in FIGS. 2 and 3, the cam finger 22 has a profile such that an upper surface 24 of the cam finger (considered when the lever arm 14 is standing in the raised or vertical position) is at the same level as the upper side of the rollers 18. This places the cam finger at the desired position for it to slip under the machine that is to be raised. A nose or lobe tip 26 of the cam finger projects a distance past the rollers, so that the lobe tip 26 can contact the underside of the machine and lift it off the floor surface when the cam jack is pushed down to its horizontal position. As shown in FIG. 3, the tip 26 is displaced outward a short distance, i.e., to the lever arm side of the pivot axis, when the lever arm member 14 is pushed down to horizontal. That is, the lobe tip 26 is held a short distance (e.g., ⅛ inch to 5/32 inch) beyond a plane that passes vertically through the axle rod 20. In this fashion, the weight of the load itself holds the cam jack locked in the raised position. It is necessary to lift up on the lever arm member 14 to release the cam jack and bring the load to the lowered position.

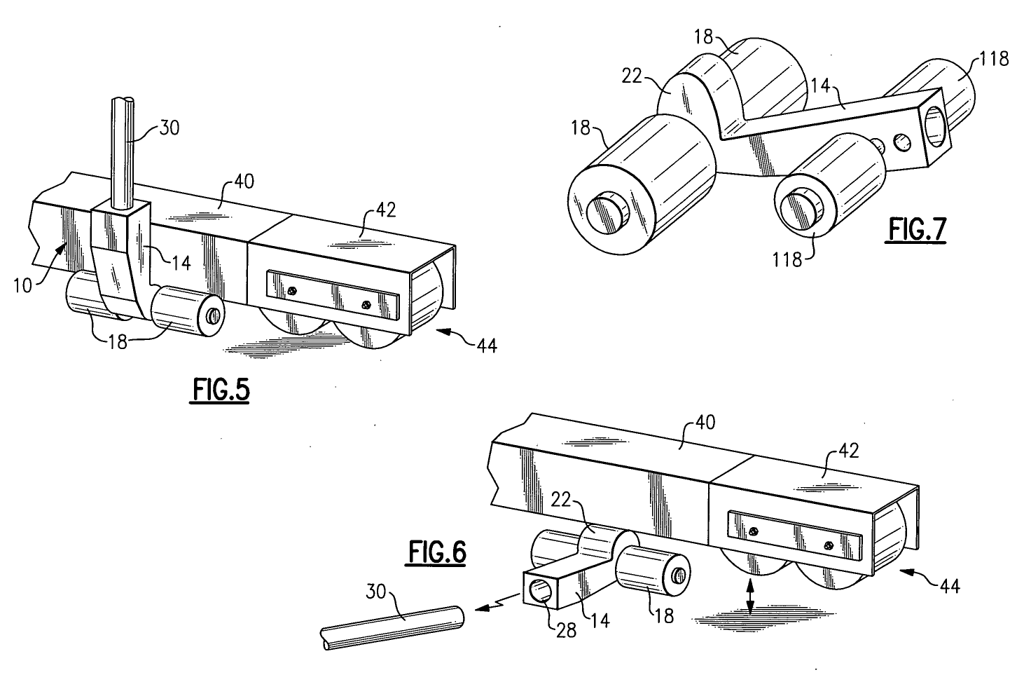

With reference to FIGS. 1 and 4, the cam jack of this embodiment has a socket 28 formed at the proximal end of the lever arm portion 14. In this example, the socket is a bore of about one inch diameter, and two to three inches deep. The socket 28 is adapted to receive a handle lever 30, which can be a rod or tube of round stock, about one-inch in diameter and three to four feet in length. The handle lever 30 is used for wheeling the cam jack into place and for lifting and releasing the load. Once the cam jack is secured into the lift position, i.e., the horizontal position, the handle lever 30 can be removed, so that the handle lever does not cause a worker to trip or stumble over it. Also, while a socket is shown here as a means for removably attaching the handle lever, other styles of fittings could be used if desired. For example, the fitting could be constituted by a round post formed on the lever arm portion 14, with a tubular handle being removably fitted onto the post.

In this embodiment, the preferred rollers 18 are 1-⅝ inch diameter and also 1-⅝ inch axially, with the axle 20 being formed of ⅝ inch round steel rod. The body lever arm portion 14 is about seven inches from the elbow 16 to the proximal end, and the latter can be a square 1-¼ inches by 1-¼ inches. The cam finger 22 projects about ½ inch beyond the rollers 18. Of course, for different applications, the cam jack can be formed with other dimensions suited to that application. The rollers 18 can be held in place on the axle 20 using spring clamps that fit into an annular groove formed on the axle.

FIGS. 5 and 6 illustrate the method of use of the cam jack of this embodiment. As shown in FIG. 5, the cam jack 10 is wheeled into place while in the upright or vertical position, i.e., with the lever arm portion 14 and handle lever 30 oriented upwards, so that the cam lobe can slide beneath the under surface of the machine to lift it. As an example, the load constituted by a lower support arm 40 of a pallet lifter or similar material handling machine, where one end 42 of the arm contains a set of wheels. Here, there is shown a two-wheel truck 44, which is to be removed and replaced. When the cam jack 10 is in place under the support arm 40 as in FIG. 5, the operator simply pushes the handle lever 30 down to rock the cam jack to a horizontal position as shown in FIG. 6. In this position, the back surface of the lever arm portion 14 is lying against the floor, and the support arm 40 is urged upward and held in an elevated position by the cam finger 22. As aforesaid, this is a stable, locked position, and the handle lever 30 can be removed. With the wheel truck 44 elevated off the floor, and being relieved of the weight of the machine, the wheel truck can be quickly changed out and replaced with a fresh set of wheels. Then, the handle lever 30 is inserted into the socket 28, and the cam lever is simply tipped back up, and removed.

FIG. 7 shows one possible alternative embodiment. Here, the body portion 12 is configured generally the same as in the first embodiment, and there is a lever arm portion 14 and a cam finger portion 22, as well as a primary set of rollers 18 supported on an axle at the elbow of the device. In this embodiment, there is an additional set of rollers 118, that are on a second axle 120, and mounted along the lever arm portion 14 displaced somewhat proximally of the primary rollers. This configuration allows the device to be rolled when there is a load being supported in the lifted position. That is, the device of this embodiment can be used as a dolly for lifting and moving heavy equipment.

While the invention has been described in detail with respect to one preferred embodiment, it should be recognized that there are many alternative embodiments that would become apparent to persons of skill in the art. Many modifications and variations are possible which would not depart from the scope and spirit of this invention, as defined in the appended claims.

We claim:

1. A cam jack for lifting a heavy article off a supporting floor surface, comprising
an L-shaped cam member unitarily formed of a single piece of steel; and having a lever arm portion, a cam finger, and an elbow formed between the lever arm portion and the cam finger;
an axle attached at said elbow and extending to right and left sides thereof; and
left and right rollers supported on said axle on respective sides of said elbow; said rollers having a predetermined diameter so as to define an upper level thereof;
said cam finger projecting from said axle at a near right angle in respect to said lever arm portion; and said cam finger having an upper surface which, when said lever arm is oriented vertically, is disposed at or below the upper level of said rollers; and the cam finger having a lobe tip which, when the lever arm is disposed horizontally, projects above the upper surface of said rollers and is displaced towards said lever arm member in respect to a vertical plane through said axle.

2. The cam jack according to claim 1 wherein said lever arm member includes a fitting for accepting a removable lever handle.

3. The cam jack according to claim 2 wherein said fitting includes a socket formed at a proximal end of said lever arm member.

4. The cam jack according to claim 1 wherein said lever arm portion is formed with planar left and right sides, a planar front surface, and a rear surface that has a major planar portion.

5. The cam jack according to claim 5 wherein said major planar portion of the rear surface is oriented at an angle of substantially ten degrees in respect to said front surface.

6. The cam jack according to claim 1 wherein said axle is formed of a single steel rod supported at said elbow and projecting to the left and right sides of the cam member.

7. The cam jack according to claim 1 further comprising a set of auxiliary rollers positioned at left and right sides of said lever arm portion proximally of the first-mentioned rollers.
